(19) United States
(12) Patent Application Publication
(10) Pub. No.: US 2024/0401573 A1
(43) Pub. Date: Dec. 5, 2024

(54) ENERGY HARNESSING SYSTEM AND ASSOCIATED METHOD

(71) Applicant: Shamir Pravinchandra BUDHDEO, Pinner (GB)

(72) Inventor: Shamir Pravinchandra BUDHDEO, Pinner (GB)

(21) Appl. No.: 18/701,252

(22) PCT Filed: Jan. 11, 2023
(86) PCT No.: PCT/GB2023/050047

§ 371 Date: Apr. 15, 2024

(51) Int. Cl. F03G 6/00; F24S 20/20; F24S 23/71; F24S 23/79; F25B 9/04

(52) U.S. Cl. CPC F03G 6/108; F24S 20/20; F24S 23/71; F24S 23/79; F25B 9/04

(57) ABSTRACT

An energy harnessing system comprising a solar collector, a solar-energy heat circulation system, a heat engine, and a refrigerant circulation system. The solar-energy heat circulation system includes a first heat exchanger 11 associated with the solar collector and communicated with at least two second heat exchangers 18a, 18b, 18c, 18d. The heat engine has at least two carbon-dioxide-sublimation-and-deposition chambers 17a, 17b, 17c, 17d, a turbine 30, and an expansion chamber 32. Each carbon-dioxide-sublimation-and-deposition chamber 17a, 17b, 17c, 17d contains one of the second heat exchangers 18a, 18b, 18c, 18d. The refrigerant circulation system is configured to cool the expansion chamber 32 and each sublimation-and-deposition chamber 17a, 17b, 17c, 17d.

The present invention relates to an energy harnessing system and a method of use thereof.

Electricity is typically generated via the use of supercritical or hypercritical steam. Fuel, such as coal or uranium, is used to generate heat for forming superheated steam from liquid water. This creates a pressure differential to drive a turbine and thereby generate electricity.

However, combustion of fossil fuels generates large amounts of carbon dioxide which contributes to climate change, and the use of nuclear energy is undesirable due to the dangerous waste products.

As such, it would be desirable to generate energy via a turbine using methods which do not require fossil fuels or uranium. For example, utilising solar or atmospheric heat sources.

However, water has a relatively high latent heat of vaporisation, a relatively high specific heat capacity, a relatively low molecular weight, but a high expansion ratio. As such, a large amount of heat energy is required to be produced to use water as a working fluid in a turbine system. Thus, it is difficult or impossible to use water as a working fluid to harness solar or atmospheric heat sources.

It would therefore be desirable to provide a system and method for driving a turbine to harness alternative sources of heat.

The present invention seeks to provide a solution to these problems.

According to a first aspect of the present invention, there is provided an energy harnessing system comprising: a solar collector having at least one reflective element; a solar-energy heat circulation system including a first heat exchanger communicated with at least two second heat exchangers, the reflective element arranged so that in use incident solar radiation is directed to the first heat exchanger, and at least one first valve for selectively communicating the first heat exchanger with at least one of the second heat exchangers; a heat engine having at least two carbon-dioxide-sublimation-and-deposition chambers having a carbon dioxide inlet and a carbon dioxide outlet and at least one of the sublimation-and-deposition chambers comprising carbon dioxide, each second heat exchanger configured to heat the associated sublimation-and-deposition chamber, a turbine fluidly communicated with the carbon dioxide outlet of each sublimation-and-deposition chamber, the turbine configured to be driven by gaseous carbon dioxide from the sublimation-and-deposition chambers, at least one expansion chamber fluidly communicated with the turbine and the carbon dioxide inlet of each sublimation-and-deposition chamber, the expansion chamber configured to receive and cool gaseous carbon dioxide from the turbine and provide cooled gaseous carbon dioxide to the sublimation-and-deposition chambers, at least one second valve configured to selectively close each carbon dioxide inlet of the carbon-dioxide-sublimation-and-deposition chamber, and a refrigerant circulation system configured to cool the expansion chamber and having a third heat exchanger configured to cool each sublimation-and-deposition chamber.

Since carbon dioxide is in the sublimation-and-deposition chambers and is used as a working fluid, heat from low temperature sources, such as solar or atmospheric sources, can be utilised. This is due to carbon dioxide having a relatively low latent heat of vaporisation, a relatively low specific heat capacity, a relatively high molecular weight, and a relatively good expansion ratio. The use of multiple sublimation-and-deposition chambers allows for a sequential and cyclical closed loop process, since one chamber can produce gaseous carbon dioxide which is deposited in a further chamber as solid carbon dioxide, since that further chamber had been evacuated. The refrigerant circulation system or heat recovery system distributes the heat energy across the system. The use of an expansion chamber helps to lower the temperature of gaseous carbon dioxide after existing the turbine, reducing any requirement to use a condenser and the associated parasitic losses. The solar collector focuses solar radiation onto the first heat exchanger to improve overall system efficiency.

Preferable and optional features of the energy harnessing system are defined in claims 2 to 17.

According to a second aspect of the invention, there is provided a method of using the energy harnessing system according to the first aspect of the invention, the method comprising the steps of: a) providing solid carbon dioxide in a first carbon-dioxide-sublimation-and-deposition chamber; b) the first heat exchanger absorbing heat; c) communicating the first heat exchanger with the second heat exchanger of a first carbon-dioxide-sublimation-and-deposition chamber, and disconnecting the first heat exchanger from the second heat exchanger of a second carbon-dioxide-sublimation-and-deposition chamber, so that the solid carbon dioxide in the first carbon-dioxide-sublimation-and-deposition chamber sublimates to form gaseous carbon dioxide; d) closing the carbon dioxide inlet of the first carbon-dioxide-sublimation-and-deposition chamber, and opening the carbon dioxide inlet of the second carbon-dioxide-sublimation-and-deposition chamber; e) the gaseous carbon dioxide flowing to and driving the turbine; f) the gaseous carbon dioxide flowing to, expanding in, and being cooled by the expansion chamber; g) the refrigerant circulation system cooling the expansion chamber; h) the gaseous carbon dioxide flowing to the second carbon-dioxide-sublimation-and-deposition chamber and being cooled by the third heat exchanger of the refrigerant circulation system to deposit as solid carbon dioxide.

The invention will now be more particularly described, by way of example only, with reference to the accompanying drawings, in which:

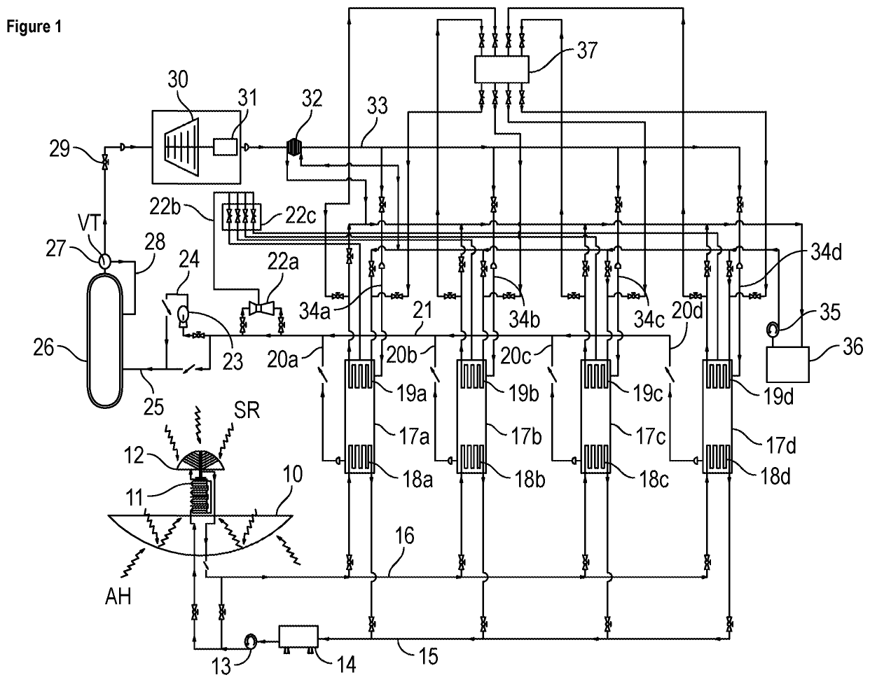

FIG. 1 shows a schematic diagram of an embodiment of the energy harnessing system in accordance with a first aspect of the invention;

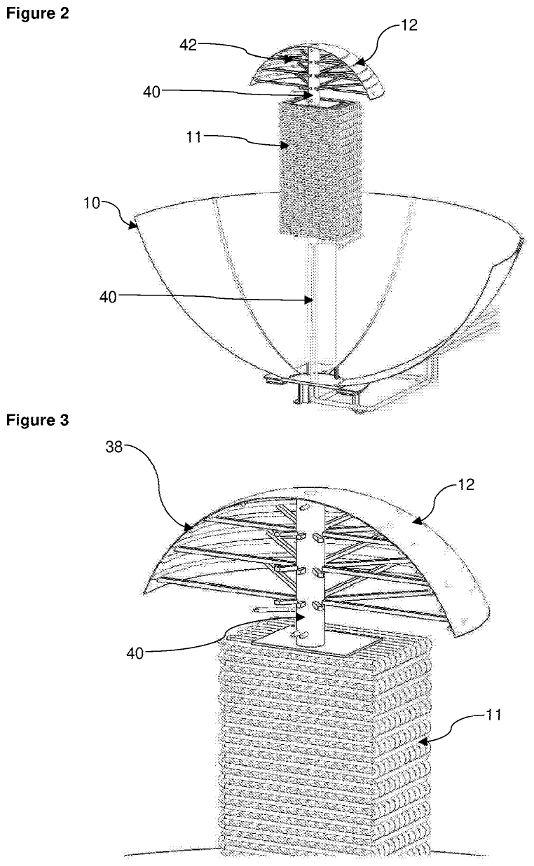

FIG. 2 shows a cut away perspective view of an embodiment of a solar collector and first heat exchanger of the energy harnessing system of FIG. 1;

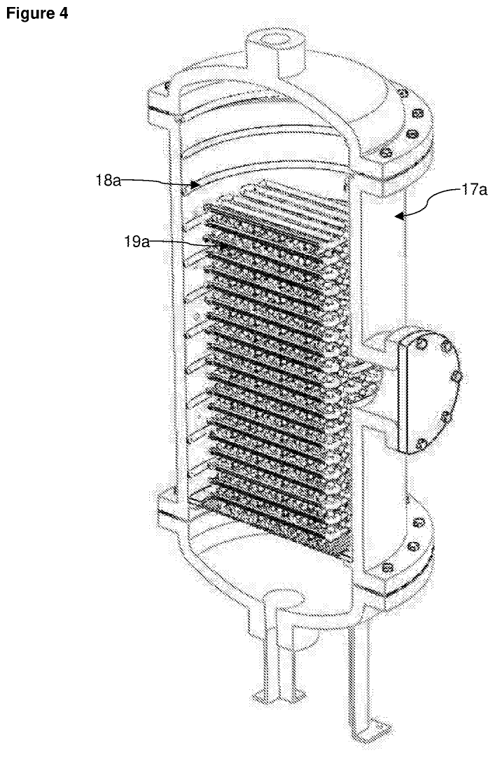

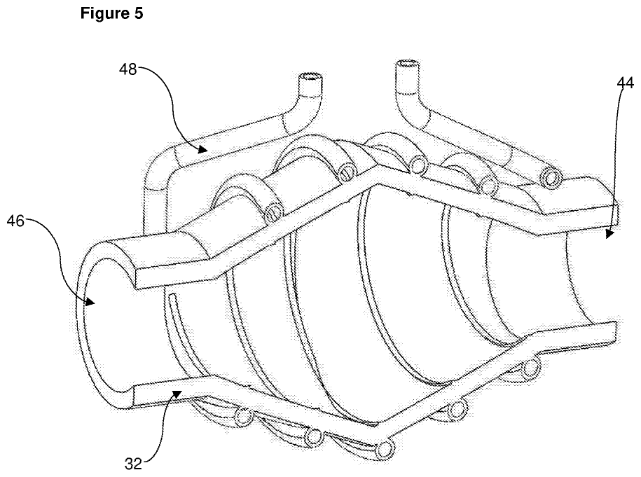

FIG. 3 shows an enlarged view of FIG. 4;

FIG. 4 shows a cut away perspective view of an embodiment of a carbon-dioxide-sublimation-and-deposition chamber of the energy harnessing system of FIG. 1; and

FIG. 5 shows a cut away perspective view of an embodiment of an expansion chamber of the energy harnessing system of FIG. 1.

Referring firstly to FIG. 1, the energy harnessing system comprises a solar collector, a solar-energy heat circulation system, a heat engine, and a refrigerant circulation system.

Referring in addition to FIGS. 2 and 3, the solar collector comprises at least one reflective element, and more preferable comprises a plurality of reflective elements. Here there is a first reflective element 10 and second reflective element 12, each being curved and having a concavity which faces the other reflective element. However, it will be appreciated that the second reflective element may not be necessary and, for example, a similarly shaped component may be used without a reflective surface for heat absorption purposes only.

The first reflective element 10 has a greater diameter than that of the second reflective element 12, and the second reflective element 12 is in use positioned above the first reflective element 10. The diameter of the second reflective element 12 is preferably 3 m. Each reflective element may be formed of polished metal, such as steel or copper. The first reflective element 10 may comprise stainless steel and the second reflective element 12 may comprise copper. The second reflective element 12 may be thin, for example being formed form 2 mm sheet. The curve of each reflective element may be parabolic, such that each may be considered to operate as a parabolic mirror. The convex surface of the reflective elements 10, 12 are preferably black to aid heat absorption.

The heat circulation system comprises a first heat exchanger 11 communicated with at least two second heat exchangers. Here there are four second heat exchangers 18a, 18b, 18c, 18d. The first heat exchanger 11 and second heat exchangers 18a, 18b, 18c, 18d each comprise serpentine, coiled, or circuitous tubing with a heat-transfer fluid flowing therein. A heat distribution conduit 16 transports the heat-transfer fluid from the first heat exchanger 11 to the second heat exchangers 18a, 18b, 18c, 18d, and a return conduit 15 returns the heat transfer fluid from the second heat exchangers 18a, 18b, 18c, 18d to the first heat exchanger 11. There is preferably at least one first valve on the heat distribution conduit 16 for selectively communicating the first heat exchanger 11 with at least one of the second heat exchangers 18a, 18b, 18c, 18d. In other words, the flow of heat-transfer fluid can be controlled so that selected one or more second heat exchangers 18a, 18b, 18c, 18d do not receive the heated heat-transfer fluid from the first heat exchanger 11, and selected one or more second heat exchangers 18a, 18b, 18c, 18d do receive the heated heat-transfer fluid. Here there is an isolation valve, which may be a ball valve such as a hand operated ball valve, on each branch of heat distribution conduit 16 which connects with the second heat exchanger. There is also a valve on each branch of the return conduit 15, which may also be an insolation valve, although a non-return valve may also be considered.

A pump 13 is used to move the heat-transfer fluid around the heat circulation system. The heat transfer fluid preferably has a latent heat of evaporation of less than 400 KJ/Kg, for example being R32. Other hydrofluorocarbons may also be considered. There may be a reservoir of heat-transfer fluid 14.

The first heat exchanger 11 is formed from copper although other materials may be considered. Preferably, the first heat exchanger 11 is elongate and has a generally cuboidal shape. The tubing of the first heat exchanger 11 preferably has a black surface for assisting radiation absorption. The inner surface of the tubes may have a raised helical ridge running therethrough. This causes turbulent flow, reduces the boundary layer within the pipes, and decreases laminar flow within the pipes, thereby increasing the transfer of heat.

There may in fact be two first heat exchangers which are connected in parallel to aid air flow therethrough.

The second reflective element 12 preferably has helical copper tubing 38 therearound which fluidly communicates with the first heat exchanger 11. As such the tubing is configured to cool or absorb heat from the second reflective element 12.

The first heat exchanger 11 and the second reflective element 12 are supported by a central column 40 from the first reflective element 10. Copper prongs 42 are also used to connect the second reflective element 12 to the central column.

There is preferably an opening at a base of the first reflective element 10 with a water collection conduit connected thereto so as to collect and distribute water which condenses on the first reflective element 10. This may provide a source of drinking or irrigation water.

Referring in addition to FIG. 4, the heat engine comprises at least two carbon-dioxide-sublimation-and-deposition chambers. Here there are four such sublimation-and-deposition chambers, which may be referred to as first, second, third and fourth sublimation-and-deposition chambers 17a, 17b, 17c, 17d. However, it will be appreciated that there may be other numbers of chambers, for example at least three or more than four sublimation-and-deposition chambers. Each sublimation-and-deposition chamber is heated by one of the second heat exchangers 18a, 18b, 18c, 18d, and preferably each second heat exchanger 18a, 18b, 18c, 18d is inside the associated sublimation-and-deposition chamber 17a, 17b, 17c, 17d. However, the interior of the second heat exchanger 18a, 18b, 18c, 18d is fluidly isolated from the relevant sublimation-and-deposition chamber 17a, 17b, 17c, 17d. The interior of the tubing of the second heat exchanger 18a, 18b, 18c, 18d may have grooving to increase the surface area and reduce the boundary layer effect by causing the flow to be turbulent as it aids in creating vortexes thus increasing the transfer of heat. The carbon-dioxide-sublimation-and-deposition chambers 17a, 17b, 17c, 17d may be painted black.

Each sublimation-and-deposition chamber 17a, 17b, 17c, 17d has a carbon dioxide inlet and a carbon dioxide outlet. Preferably, at least one of the sublimation-and-deposition chambers contains carbon dioxide, which may initially be in a solid form. Most preferably three of the chambers 17a, 17c, 17d are primed with solid carbon dioxide, and one 17b is evacuated.

Each sublimation-and-deposition chamber 17a, 17b, 17c, 17d also contains a third heat exchanger 19a, 19b, 19c, 19d which is part of the refrigerant circulation system, and which will be described in further detail subsequently.

One of the second and third heat exchangers 17a, 17b, 17c, 17d; 19a, 19b, 19c, 19d is preferably arranged in a rectangular arrangement in the centre of the sublimation-and-deposition chamber 18a, 18b, 18c, 18d, and the other of the second and third heat exchanger 17a, 17b, 17c, 17d; 19a, 19b, 19c, 19d is preferably arranged helically around the interior of the sublimation-and-deposition chamber. In an in-use arrangement, an inlet of the second heat exchanger 17a, 17b, 17c, 17d is at the top of the sublimation-and-deposition chamber, and an outlet is at the bottom. Additionally, in an in-use arrangement, an inlet of the third heat exchanger 19a, 19b, 19c, 19d is at the bottom, and the outlet is at the top.

The heat engine preferably further comprises a pressure chamber 26 having an inlet, an outlet, and a valve at the outlet to permit storing and pressuring of gaseous carbon dioxide in the pressure chamber 26. The valve may be an isolation valve, or a pressure regulating valve, for example.

A conduit 20a, 20b, 20c, 20d, 21, 24, 25 connects each the carbon dioxide outlet of each sublimation-and-deposition chamber with the inlet of the pressure chamber 26. There is preferably a Venturi vacuum tube 22a attached to a section of the conduit 21 in a bleed-off configuration which allows it to be isolated from the conduit 21 when not required. The venturi vacuum tube 22a has a suction pipe 22b connected to a vacuum valve array 22c which allows for selection of which sublimation-and-deposition chamber will be evacuated.

There is preferably also a compressor 23 connected to a section of the conduit 24 for evacuating the sublimation-and-deposition chambers 18a, 18b, 18c, 18d.

The heat engine further comprises a turbine 30 in a chamber, and an associated generator 31. A fluid inlet of the turbine 30 or chamber is connected to the outlet of the pressure chamber 26. Turbine blades of the turbine 30 are rotatable by the gaseous carbon dioxide received thereby. A shaft of the turbine 30 preferably connects to a gearbox which connects to a generator 31 to create electricity. There may also be a set of nozzles at or adjacent to the inlet of the turbine 30 for increasing a velocity of carbon dioxide gas.

There may be a throttling valve 29 before the inlet of the turbine 30 for adjusting an amount or velocity of carbon dioxide reaching the turbine 30.

Between the turbine 30 and the pressure chamber 26 there is preferably a vortex tube 27 for splitting carbon dioxide received from the pressure chamber 26 into hot and cold streams. The cold stream is diverted back into the pressure chamber 26 via a conduit 28. Although it is shown in FIG. 1 that the conduit 28 connects directly back into the pressure chamber 26, in reality, the conduit 28 preferably connects to a conduit upstream of the compressor 23, for example conduit 21, so that the compressor 23 can be used to pressurise and feed the cold stream into the pressure chamber 26.

A fluid outlet of the turbine 30 is fluidly communicated with the carbon dioxide inlet of the carbon-dioxide-sublimation-and-deposition chambers 17a, 17b, 17c, 17d by conduits 33, 34a, 34b, 34c, 34d. There is at least one valve configured to selectively close each of the carbon dioxide inlets. In other words, at least one selected carbon dioxide inlet can be closed to the carbon dioxide from the turbine 30, and at least one selected carbon dioxide inlet can be open to the carbon dioxide from the turbine 30. Here there is a valve on each branch 34a, 34b, 34c, 34d of the conduit leading to the carbon-dioxide-sublimation-and-deposition chambers 17a, 17b, 17c, 17d.

Referring now to FIG. 5, fluidly communicated between the turbine 30 and the carbon dioxide inlet there is an expansion chamber 32 configured to receive and cool gaseous carbon dioxide from the turbine 30, and provide cooled gaseous carbon dioxide to the carbon-dioxide-sublimation-and-deposition chambers 17a, 17b, 17c, 17d. The expansion chamber 32 has a carbon dioxide inlet 44 and a carbon dioxide outlet 46, and preferably has a biconical form. In other words, a diameter of the expansion chamber 32 smoothly increases from the inlet 44 before smoothly decreasing to the outlet 46. A maximum diameter of the expansion chamber 32 may be at or adjacent to the centre of the expansion chamber 32. There is preferably tubing 48 which is part of the refrigerant circulation system coiled around the expansion chamber 32 for providing cooling thereto. An internal surface of the expansion chamber 32 has helical grooves which will cause the gas flowing therethrough to form a vortex and thus turbulent flow to increase transfer of heat to the surface of the expansion chamber 32.

There is preferably a plurality of expansion chambers 32 in a series to reduce the temperature of carbon dioxide to −70° C. The temperature is not reduced below-70° C. to avoid carbon dioxide being deposited in the expansion chamber 32. It will be appreciated that the expansion chamber could be omitted.

The refrigerant circulation system comprises the third heat exchangers 17a, 17b, 17c, 17d, the coiled tubing for cooling the expansion chamber 32, a pump 35, a cold fluid reservoir 36, and a manifold 37. A refrigerant flows through these components, and this is preferably a hydrofluorocarbon, most preferably R32. Valves in the manifold 37 allow control of the flow of the refrigerant to the different components of the refrigerant circulation system, as will be better understood below.

In use, the energy harnessing system may be positioned in any position which preferably receives a large amount of sunlight. For example, systems suitable for use by a single or small numbers of households may be positioned on rooftops in urban areas. Alternatively, larger scale systems may be positioned on land outside urban areas. The system, or a variant thereof, could be used to replace boilers or similar devices in domestic settings.

The system is primed by providing the first, third, and fourth carbon-dioxide-sublimation-and-deposition chambers 18a, 18c, 18d with solid carbon dioxide therein. This is achieved by initially evacuating all of the chambers 18a, 18b, 18c, 18d, and then pumping carbon dioxide into the relevant three chambers 18a, 18c, 18d. The chambers, or elsewhere in the system, may have an inlet valve for permitting initial pumping of carbon dioxide. Since the chambers 18a, 18c, 18d are evacuated, the carbon dioxide will reduce in temperature and solidify or deposit into these three chambers. Heat given off by the depositing carbon dioxide can be absorbed by the refrigerant, which may then vaporise.

Thus, the first, third and fourth carbon-dioxide-sublimation-and-deposition chambers 17a, 17c, 17d have solid carbon dioxide therein, and the second carbon-dioxide-sublimation-and-deposition chamber 17b is evacuated. Approximately 80% of the volume of the first, third and fourth carbon-dioxide-sublimation-and-deposition chambers 17a, 17c, 17d is filled with solid carbon dioxide.

The first reflective element 10 of the solar collector reflects incident solar radiation SR onto the first heat exchanger 11 and/or the concave reflective surface of the second reflective element 12. The second reflective element 12 reflects reflected light from the first reflective element 10 onto the first heat exchanger 11. Furthermore, the first heat exchanger 11 may absorb ambient atmospheric heat energy AH.

The heat transfer fluid is preferably R32 which has a boiling point of −51° C. The first heat exchanger 11 is made from copper. Copper, in an equilibrium state when exposed to sunlight, will achieve a median temperature of 60° C. This equilibrium temperature is achieved when the rate of heat loss of the copper via radiation, convection and conduction is equivalent to the heat absorption of copper via radiation, convection and conduction. Therefore, the copper of the first heat exchanger 11 will not reach equilibrium as the energy being absorbed by the first heat exchanger 11 is being carried away into the heat engine. A negative entropy gradient is always maintained.

The first heat exchanger 11 absorbs energy by radiation. Stefan Boltzman equations of radiation absorption can be used to calculate the amount of energy absorbed.

$$P = ε σ A {T}^{4}$$

where P is the power, ε is the emissivity of the first heat exchanger, σ is the Stefan-Boltzmann constant (5.67×10⁻⁸ W m⁻² K⁻⁴), A is the area of the first heat exchanger, and T is the temperature differential.

The largest component of energy absorption or emission is the temperature differential. The heat exchanger will be at −51° C. and as such given that copper's equilibrium temperature is 60° C., the overall radiation gain will be extremely large. Since surface area is another key factor in radiation absorption, a loop density of the first heat exchanger 11 is high.

The surface area of the heat exchanger is the diameter of the pipes multiplied by the length of the copper pipe. The diameter of the pipes could be made smaller, but this will increase the internal resistance of the pipes and increase the work of pumps in the system. The absorption area of the heat collection exchanger is therefore IT multiplied by the diameter of the tube, which is preferably 12 mm, multiplied by the overall length of the copper in the first heat exchanger 11. The surface area and thermal difference are key parameters in increasing energy absorption. The emissivity or absorption of matt black painted copper is 0.9 of the total radiation that falls upon it.

The presence of the reflective elements 10, 12 assists with increasing the amount of solar energy incident on the first heat exchanger 11.

Since the first reflective element 10 is preferably formed from steel, which has a low thermal absorption rate compared to copper, and since the polished side of the parabolic dish will reflect solar radiation onto the first heat exchanger 11, the first heat exchanger 11 will be at a relatively low temperature. Furthermore, the first heat exchanger 11 is in contact with the first reflective element 10. This will result in the first reflective element 10 becoming chilled since the heat from the first reflective element 10 will be absorbed by the heat-transfer fluid. Chilling the first reflective element 10 will result in condensation of water onto the first reflective element 10, which can be collected and utilised.

The second reflective element 12 also collects heat energy via radiation, and this may be transferred to the first heat exchanger 11 via conduction through the copper prongs.

In view of the use of copper for the first heat exchanger 11, and steel for the first reflective element 10, there may be a thermoelectric current, which feasibly could be harnessed.

Additionally, the first heat exchanger 11 may absorb energy through conduction, as per the following equation:

$$\frac{Q}{t} = \frac{k A ( {T}_{2} - {T}_{1} )}{d}$$

where A is surface area of the first heat exchanger 11, T₂−T₁ is difference between the heat exchanger surface temperature and the surrounding temperature, k is the heat transfer coefficient of the material of the first heat exchanger 11, and d is the thickness of the pipe.

Since the heat transfer fluid keeps the temperature differential at a maximum, heat absorption via conduction is maximised.

The first heat exchanger 11 also absorbs energy via convection, due to the high temperature differential between the air adjacent to the first heat exchanger 11 and general atmospheric air. This will cause a large amount of air flow which causes turbulent flow around and between the coils of the first heat exchanger 11, which in turn will assist in heat transfer.

It is estimated that the solar collector and first heat exchanger 11 will absorb at least 5% of the overall solar radiance. Overall solar radiance is estimated to be 2064 KWh/m² in India, and between 750 KWh/m² to 1100 KWh/m² in the UK.

The temperature gradient utilised via the first heat exchanger 11 is sufficiently large that energy absorption will continue throughout a 24-hour period. Peak energy collection will be during periods of high solar radiation, but wind movement and reflective thermal radiation at night will also be absorbed.

As such, the first heat exchanger 11 absorbs heat energy via multiple different mechanisms.

The first valve which controls the fluid flow to the second heat exchanger 18a associated with the first carbon-dioxide-sublimation-and-deposition chamber 17a is opened. The pump 13 may then be activated to move the heat-transfer fluid, which may be R32, from the first heat exchanger 11 to the second heat exchanger 18a of the first carbon-dioxide-sublimation-and-deposition chamber 17a. The R32 may be in a gaseous state after being heated by the first heat exchanger 11.

The heat-transfer fluid heats the second heat exchanger 18a in the first carbon-dioxide-sublimation-and-deposition chamber 17a and therefore heats and sublimates the solid carbon dioxide therein. The pressure in the first carbon-dioxide-sublimation-and-deposition chamber 17a therefore increases.

The heat-transfer fluid will change phase into liquid giving up 382 KJ/kg. This will convert approximately 0.67 kg of solid carbon dioxide in the first carbon-dioxide-sublimation-and-deposition chamber 17a into carbon dioxide gas. This gas will expand into the vacant space in the cylinder which will contain solid carbon dioxide as well. So, the first kilogram of carbon dioxide to expand will expand into a smaller 0.002 m³ volume of space creating 2.65 MPa of pressure.

The heat-transfer fluid is re-liquefied by the solid carbon dioxide during this process, and is returned to the first heat exchanger 11.

The carbon dioxide gas from the first carbon-dioxide-sublimation-and-deposition chamber 17a flows through to the pressure chamber 26. The compressor 23 may assist with driving the gas to the pressure chamber 26.

The pressure in the pressure chamber 26 increases to a pre-determined level, preferably to 100 bar (10 MPa). At this pressure the carbon dioxide is in a supercritical state. The pressure chamber 26 may act as a capacitor as the mass of carbon dioxide therein will be sufficient to power the turbine 30 for approximately 40 minutes.

The valve at the outlet of the pressure chamber 26 is opened and the carbon dioxide flows into the vortex tube 27. The cold stream is diverted back to the pressure chamber 26 via the compressor 23, and the hot stream continues to the turbine 30. The pressure of the cold stream on exit from the vortex tube 27 would be below 100 bar (10 MPa), and so the compressor 23 is required to repressurise the cold stream.

The throttling valve 29 is set to provide a suitable and stable amount of carbon dioxide to the turbine 30.

The turbine 30 is therefore driven and electricity is generated.

The carbon dioxide gas then exits the turbine 30 and enters the expansion chamber 32, where the pressure and temperature of carbon dioxide gas is reduced. The temperature may be reduced to −70° C. The tubing 48 coiled around the expansion chamber 32 with refrigerant flowing therethrough may absorb the heat associated with the expansion of the carbon dioxide.

The carbon dioxide thereafter flows to and through the carbon dioxide inlet of the second carbon-dioxide-sublimation-and-deposition chamber 18b, since the carbon dioxide inlets of the other carbon-dioxide-sublimation-and-deposition chambers 18a, 18c, 18d are closed. The second carbon-dioxide-sublimation-and-deposition chamber 18b has been cooled by its third heat exchanger 17b of the refrigeration circulation system, and the temperature of the refrigerant, R32, is −78° C. The second carbon-dioxide-sublimation-and-deposition chamber 18b would be at below atmospheric pressure due to the venturi vacuum tube, and the associated vacuum line would now be closed.

As the carbon dioxide enters the second carbon-dioxide-sublimation-and-deposition chamber 18b it instantly deposits to form solid carbon dioxide.

After cooling by the expansion chambers 32, the carbon dioxide on entry to second carbon-dioxide-sublimation-and-deposition chamber 18b will be at −70° C. This means that in order to recondense the carbon dioxide within the second carbon-dioxide-sublimation-and-deposition chamber 18b, only −9° C. of energy needs to be extracted from the carbon dioxide gas in addition to its latent heat of condensation.

This is nine multiplied by the Specific Heat Capacity of carbon dioxide which is nine multiplied by 0.846 KJ/kg of carbon dioxide plus its latent heat of condensation 571 KJ/kg. This equates to approximately 580 KJ/kg. The latent heat of vaporisation of R32 is 382 KJ/kg. So approximately 1.5 kg of R32 will be required to flow into the second carbon-dioxide-sublimation-and-deposition chamber 18b to recondense 1 kg of carbon dioxide.

The condensation rate of carbon dioxide must equal the mass flow of carbon dioxide exiting the turbine 30.

As carbon dioxide condenses, its rapid contraction will result in a negative pressure at the exit of the turbine 30. This will result in a greater work efficiency within the turbine 30 which will cool the carbon dioxide at the exit, thereby reducing the amount of heat to be recovered by the biconical expansion chambers 32. This in turn results in lower pumping and parasitic energy losses.

The carbon dioxide entering the carbon-dioxide-sublimation-and-deposition chambers 17a, 17b, 17c, 17d should deposit at the base thereof and it is for this reason that the refrigerant, R32, is pumped into the third heat exchangers 17a, 17b, 17c, 17d from the bottom. Carbon dioxide, when condensing, will give up its latent heat of condensation and this heat will transfer to the lowest point of entropy in the carbon-dioxide-sublimation-and-deposition chamber 18b, which is the point of entry of the R32. The R32 will be flowing in both the second and third heat exchangers.

Carbon dioxide condensing at the base of the carbon-dioxide-sublimation-and-deposition chamber 18b will ensure the largest volume available for incoming carbon dioxide to expand into and cool. This assists in the cooling efficiency of the carbon dioxide. The thermal conductivity of solid carbon dioxide is lower than that of gaseous carbon dioxide. Therefore, when the carbon dioxide solidifies on the heat exchanger tubing at the base of the carbon-dioxide-sublimation-and-deposition chamber 18b, the overall thermal conductivity will decrease. The solid carbon dioxide will be at a lower temperature than the incoming R32 and as such further deposition of carbon dioxide should occur from the base upwards.

Once the second carbon-dioxide-sublimation-and-deposition chamber 18b is full of the defined mass and volume, the valve will close and the exit carbon dioxide from the turbine 30 will be directed to another carbon-dioxide-sublimation-and-deposition chamber.

The equilibrium state will be where there is carbon dioxide in the pressure chamber 26, two carbon-dioxide-sublimation-and-deposition chambers will be in an expanding phase, and two cylinders will be in a condensing cycle.

The deposition process in the second carbon-dioxide-sublimation-and-deposition chamber 18b generates heat which is absorbed by the refrigerant, R32, which is converted into gas. The gaseous refrigerant is diverted into the manifold 37 and then into the third heat exchanger 19c of the third carbon-dioxide-sublimation-and-deposition chamber 17c.

Since the third carbon-dioxide-sublimation-and-deposition chamber 17c contains solid carbon dioxide, the gaseous refrigerant is cooled to below-51° C. (the boiling point of R32) and forms a liquid. The R32 is then returned to the cold fluid reservoir 36, via the manifold 37 and/or pump 35.

The first carbon-dioxide-sublimation-and-deposition chamber 17a is eventually depleted of carbon dioxide, and the compressor 23 evacuates the carbon-dioxide-sublimation-and-deposition chamber so assist with carbon dioxide deposition in a subsequent stage.

The process is sequential and cyclical in nature and so every carbon-dioxide-sublimation-and-deposition chamber will undergo sublimation and deposition at different cycles, with the respective second heat exchangers receiving hot heat-transfer fluid in turn.

It will be appreciated that the solar collector may be omitted in some instances to allow modular connection with different heat collection methods.

It is therefore possible to provide a system which allows the harnessing of low temperature energy sources.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. An energy harnessing system comprising:
a solar collector having at least one reflective element;
a solar-energy heat circulation system including a first heat exchanger communicated with at least two second heat exchangers, the reflective element arranged so that in use incident solar radiation is directed to the first heat exchanger, and at least one first valve for selectively communicating the first heat exchanger with at least one of the second heat exchangers;
a heat engine having
at least two carbon-dioxide-sublimation-and-deposition chambers having a carbon dioxide inlet and a carbon dioxide outlet and at least one of the sublimation-and-deposition chambers comprising carbon dioxide, each second heat exchanger configured to heat the associated sublimation-and-deposition chamber,
a turbine fluidly communicated with the carbon dioxide outlet of each sublimation-and-deposition chamber, the turbine configured to be driven by gaseous carbon dioxide from the sublimation-and-deposition chambers,
at least one expansion chamber fluidly communicated with the turbine and the carbon dioxide inlet of each sublimation-and-deposition chamber, the expansion chamber configured to receive and cool gaseous carbon dioxide from the turbine and provide cooled gaseous carbon dioxide to the sublimation-and-deposition chambers,
at least one second valve configured to selectively close each carbon dioxide inlet of the carbon-dioxide-sublimation-and-deposition chamber, and
a refrigerant circulation system configured to cool the expansion chamber and having a third heat exchanger configured to cool each sublimation-and-deposition chamber.

2. An energy harnessing system as claimed in claim 1, wherein the solar-energy heat circulation system and/or the refrigerant circulation system comprises a hydrofluorocarbon.

3. An energy harnessing system as claimed in claim 2, wherein the hydrofluorocarbon is R32.

4. An energy harnessing system as claimed in any one of the preceding claims, wherein the reflective element is curved.

5. An energy harnessing system as claimed in any one of the preceding claims, wherein there is a first reflective element and a second reflective element, each reflective element being curved and having concavities facing each other.

6. An energy harnessing system as claimed in claim 5, wherein the first reflective element has a larger diameter than that of the second reflective element, the first heat exchanger being between the first and second reflective elements.

7. An energy harnessing system as claimed in any one of the preceding claims, wherein a surface of the first heat exchanger is black.

8. An energy harnessing system as claimed in any one of the preceding claims, wherein the reflective element has a water collection conduit at a base thereof for distributing water condensed on the reflective element.

9. An energy harnessing system as claimed in any one of the preceding claims, further comprising a pressure chamber having an inlet communicated with the carbon-dioxide-sublimation-and-deposition chambers and an outlet communicated with the turbine, the pressure chamber having a valve at the outlet so as to permit storing and pressurising of gaseous carbon dioxide.

10. An energy harnessing system as claimed in claim 9, further comprising a vortex tube at or adjacent to an outlet of the pressure chamber, the vortex tube configured to split carbon dioxide into hot and cold streams, permitting the hot stream to proceed to the turbine, and redirecting the cold stream back to the pressure chamber.

11. An energy harnessing system as claimed in any one of the preceding claims, wherein there are four carbon-dioxide-sublimation-and-deposition chambers.

12. An energy harnessing system as claimed in any one of the preceding claims, wherein the second and third heat exchangers are inside the carbon-dioxide-sublimation-and-deposition chambers.

13. An energy harnessing system as claimed in any one of the preceding claims, further comprising a compressor configured to evacuate the carbon-dioxide-sublimation-and-deposition chambers.

14. An energy harnessing system as claimed in claim 13, wherein the compressor is a screw compressor.

15. An energy harnessing system as claimed in any one of the preceding claims, wherein comprising a venturi valve configured to assist with evacuation of the carbon-dioxide-sublimation-and-deposition chambers.

16. An energy harnessing system as claimed in any one of the preceding claims, wherein the expansion chamber has a biconical shape.

17. An energy harnessing system as claimed in any one of the preceding claims, wherein the solar collector and first heat exchanger are disconnectable from the second heat exchangers.

18. A method of using the energy harnessing system as claimed in any one of the preceding claims, the method comprising the steps of:
a) providing solid carbon dioxide in a first carbon-dioxide-sublimation-and-deposition chamber;
b) the first heat exchanger absorbing heat;
c) communicating the first heat exchanger with the second heat exchanger of a first carbon-dioxide-sublimation-and-deposition chamber, and disconnecting the first heat exchanger from the second heat exchanger of a second carbon-dioxide-sublimation-and-deposition chamber, so that the solid carbon dioxide in the first carbon-dioxide-sublimation-and-deposition chamber sublimates to form gaseous carbon dioxide;
d) closing the carbon dioxide inlet of the first carbon-dioxide-sublimation-and-deposition chamber, and opening the carbon dioxide inlet of the second carbon-dioxide-sublimation-and-deposition chamber;
e) the gaseous carbon dioxide flowing to and driving the turbine;
f) the gaseous carbon dioxide flowing to, expanding in, and being cooled by the expansion chamber,
g) the refrigerant circulation system cooling the expansion chamber,
h) the gaseous carbon dioxide flowing to the second carbon-dioxide-sublimation-and-deposition chamber and being cooled by the third heat exchanger of the refrigerant circulation system to deposit as solid carbon dioxide.
